(19) United States
(12) Patent Application Publication
(10) Pub. No.: US 2007/0117737 A1
(43) Pub. Date: May 24, 2007

(54) Particles comprising discrete fine-particulate surfactant particles

(76) Inventors: Rene-Andres Artiga Gonzalez, Dusseldorf (DE); Volker Blank, Dusseldorf (DE); Stefan Hammelstein, Dusseldorf (DE); Ingrid Kraus, Dusseldorf (DE); Josef Markiefka, Dusseldorf (DE); Berthold Schreck, Dusseldorf (DE); Mario Sturm, Leverkusen (DE)

Correspondence Address: PAUL & PAUL, 2000 MARKET STREET, PHILADELPHIA, PA, 19103-3229, US

(21) Appl. No.: 11/516,942

(22) Filed: Sep. 6, 2006

Related U.S. Application Data
(63) Continuation of application No. PCT/EP05/01753, filed on Feb. 19, 2005.

(30) Foreign Application Priority Data
Mar. 6, 2004 (DE) 10 2004 011 087.5

(51) Int. Cl. C11D 17/00

(52) U.S. Cl. 510/446

(57) ABSTRACT

Particles, particularly washing, cleaning and/or care product particles, particularly washing, cleaning and/or care product particles, having a bulk weight greater than 450 g/l, particularly 500 g/l to 1200 g/l, characterized in that the particles have a compound mixture and fine-particulate surfactant particles, which have a particle diameter d₅₀ ranging from 0.05 mm to 0.6 mm, a dust value of =0% to a maximum of 0.1%, at least 1% by weight to a maximum of 30% by weight of a surfactant, and at least 10% by weight to a maximum of 40% by weight of sodium carbonate. The indicated weights refer to the total weight of the fine-particulate surfactant particles, comprise, at least in part, discrete surfactant particles, and have a dust value ranging from =0% to =0.2%.

### CROSS-REFERENCE TO RELATED APPLICATIONS

This application is a continuation under 35 U.S.C. § 365(c) and 35 U.S.C. § 120 of International Application PCT/EP2005/001753, filed Feb. 19, 2005. This application also claims priority under 35 U.S.C. § 119 of German Application DE 10 2004 011 087.5, filed Mar. 6, 2004. Each of the applications is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention relates to particles comprising a mixture of compounds and fine particulate surfactants, together with corresponding agents, such as detergents, cleansing agents or care products as well as processes for their manufacture.

Agents in particle form, such as detergents, cleansing agents or care products are usually manufactured by spray-drying processes. When manufacturing powdered detergents, an aqueous slurry is formed in a first step. The slurry comprises thermally stable detergent ingredients such as surfactants and builders, which essentially neither volatilize nor decompose under the conditions of spray-drying. The slurry is then pumped into a spray tower and sprayed through the spray valves located in the upper part of the spray tower. Heated rising air dries the slurry and evaporates the inherent water, such that at the discharge unit of the tower, where the temperatures are 80-120° C., the detergent ingredients are obtained as powder. Additional temperature labile ingredients, such as bleaching agents or fragrances, are then blended with the powder.

Devices for spray-drying water-containing compositions are known from the prior art. Frequently used devices are spray towers with nebulizing spray valves, for example, that are used to prepare a powdered product, particularly from liquid starting materials, such as solutions, suspensions or melts. For this, the aqueous liquid is mostly atomized with pressure injectors and then dried with hot gas in a directional or counter current. The dry product is then separated by means of a cyclone or filter. When a melt is atomized and solidified in cold gas, then this is called prilling.

Additional known spray-driers are rotating disk towers. Like the spray towers, they are short-time driers. They use rotating disks for atomization and in comparison with spray towers are compactly built. The advantage of the atomizing disks is their insensitivity to blockages of the nozzles and vastly changing liquid throughputs.

Moreover, spray-driers are known with integrated fluidized beds. By incorporating a fluidized bed at the foot of the spray tower, the product can be dried and classified pneumatically there. The drying gas with the fine dust is removed for example, in the upper part of the tower at the tower head and the fines are returned into the tower after the separation. Therefore comparatively sticky and slow-drying raw materials can also be processed. Well dispersible particles are obtained as the product, which are larger and therefore mainly lower in fines than the powder from the spray towers and particularly the disk towers.

In the broader sense, fluidized bed spray granulators (agglomeration driers) are comparable with spray-driers, which are used to manufacture granulates of 0.3 mm to several mm from atomizable solutions, suspensions and melts. Two-component spray valves are often used for atomization. The product is mostly compact and resistant to abrasion and characterized by a relatively high bulk density. The rate of dissolution, compared with other spray-dried products, is therefore lower. This type of granulator can also be used for coating granules; in which case it is mostly operated in a discontinuous manner.

(2) Description of Related Art, Including Information Disclosed Under 37 C.F.R. §§ 1.97 and 1.98.

International Patent Applications WO 00/77148 (EP-A1 1 10 48 03), WO 00/77149 (EP-A1 1 10 48 04), WO 00/77158 (EP-A1 1 10 48 06), WO 00/23560 (EP-A1 1 04 11 39), WO 98/10052 (EP-A1 0 93 62 69), for example, describe granules as carrier materials for surfactants for detergents. The bulk densities of the materials disclosed in these patent applications amount to at least 500 g/l.

The above-mentioned surfactant-containing detergents known from the prior art have, inter alia, the disadvantage that the surfactant-containing particles, due to the adhesive properties of the surfactant, form agglomerates, the particles of which exhibiting a strong cohesion from the surfactants and as a result possess a reduced rate of dissolution, poor free-flowability, increased sedimentation and/or increased clump test values. Due to the agglomerate formation caused by the surfactants, an increasingly poor free-flowability is observed, particularly for surfactant-containing agents with high bulk densities.

Another disadvantage is that the surfactant-driven adhesive contact of a number of such agglomerates directly leads to cluster formation that is associated with the danger of a gelification. Gelification can lead to increased residues in the dispensing draw and/or detergent residues on the fabrics washed with the detergent. It should be emphasized that gelification can even be caused by several and/or a few particles adhered together because of the surfactant.

### BRIEF SUMMARY OF THE INVENTION

Accordingly, the object of the invention was to at least partially alleviate or even avoid the above-mentioned disadvantages of surfactant-containing agents, such as detergents, cleansing agents and/or care products. A subject of the present invention consists of particles, particularly detergent-, cleansing- and/or care product particles preferably with a bulk density of at least 400 g/l, advantageously greater than 450 g/l, particularly from 500 g/l to 1,200 g/l, wherein the particles comprise a compound mixture and fine particulate surfactant particles, at least partially as discrete surfactant particles, which have
a particle diameter d₅₀ of 0.05 mm to 0.6 mm;
a fines content of ≧0% and maximum 0.1%;
at least 1 wt. % to maximum 30 wt. % surfactant; and
at least 10 wt. % to maximum 40 wt. % sodium carbonate;
   wherein the indicated weight percentages are based on the total weight of the fine particulate surfactant particles, and the particles preferably have a fines content of ? 0% to ≦0.2%.

### BRIEF DESCRIPTION OF THE SEVERAL VIEWS OF THE DRAWING(S)

Not Applicable

### DETAILED DESCRIPTION OF THE INVENTION

The inventive particles comprising a compound mixture and the discrete fine particulate surfactant particles can have the following advantages:

high solubility, and/or

high bulk density with simultaneous good free-flowability, and/or

low fines contents, and/or

reduced gelification.

The starting point for the manufacture of the inventive particles, particularly detergent-, cleansing agent- and/or care product particles are fine particulate surfactant particles that have

a particle diameter d₅₀ of 0.05 mm to 0.6 mm;

a fines content of ≧0% and maximum 0.1%;

at least 1 wt. % to maximum 30 wt. % surfactant; and

at least 10 wt. % to maximum 40 wt. % sodium carbonate.

The indicated weight percentages are based on the total weight of the fine particulate surfactant particles.

The fine particulate surfactant particles can additionally comprise:

at least 1 wt. % to maximum 40 wt. % sodium hydrogen carbonate; and/or

at least 1 wt. % to maximum 50 wt. % sodium sulfate;

wherein the indicated weight percentages are based on the total weight of the fine particulate surfactant particles.

The fine particulate surfactant particles can be present as the direct spray-dried product. In the context of the present invention, a direct spray-dried product is understood to mean a product that is obtained by spray-drying without any further after treatment. Particularly in regard to the dispersion of the fine particulate surfactant particles, it should be noted that the reported particle size distributions relate to the direct spray-dried product.

Although surfactant particles are known to exhibit poor dissolution kinetics because the surfactant particles are usually sticky and agglomerate to form large particles, it has now been determined that the fine particulate surfactant particles used as the starting point for manufacturing inventive particles exhibit no, or a markedly reduced tendency, to form agglomerates with each other.

The fine particulate surfactant particles can exist as primary fine particulate surfactant particles and/or secondary fine particulate surfactant particles. Primary fine particulate surfactant particles are particles that do not agglomerate with each other to particles with larger diameter as a result of their surfactant controlled adhesive properties. On the other hand, secondary fine particulate surfactant particles concern particles that agglomerate to particles with larger diameter as a result of their surfactant controlled adhesive properties.

The amount of primary and secondary fine particulate surfactant particles can vary widely. For example, at least 10 wt. %, advantageously at least 30 wt. %, preferably at least 50 wt. %, more preferably at least 70 wt. % and particularly preferably at least 90 wt. % of the fine particulate surfactant particles can be present as the primary fine particulate surfactant particles, based on the total weight of the fine particulate surfactant particles.

However, depending on the method for manufacturing the fine particulate surfactant particles, it is possible that at least 10 wt. %, advantageously at least 30 wt. %, preferably at least 50 wt. %, more preferably at least 70 wt. % and particularly preferably at least 90 wt. % of the fine particulate surfactant particles are present as the secondary fine particulate surfactant particles, based on the total weight of the fine particulate surfactant particles.

It was found that one can significantly or even completely reduce adhesivity, particularly on the surface of fine particulate surfactant particles, by producing fine particulate surfactant particles that comprise sodium carbonate, sodium hydrogen carbonate and/or sodium sulfate. Adhesivity, due to the surfactant on the outer surface of fine particulate surfactant particles, when it is actually inordinately high, can eventually be eliminated by treating the surface with sodium carbonate, sodium hydrogen carbonate and/or sodium sulfate.

The fine particulate surfactant particles used to manufacture inventive particles can have a surfactant concentration gradient, wherein the surfactant concentration, given in wt. %, increases towards the direction of the particle core.

Preferably, the outer upper surface of the fine particulate surfactant particles is exempt from surfactant. The amount of surfactant at the outer surface of the fine particulate surfactant particles with respect to the total surfactant content by weight of these fine particulate surfactant particles can represent ≧0 wt. % to maximum 5 wt. %, advantageously ≧0 wt. % to 1 wt. %, preferably ≦0.1 wt. % and most preferably ≧0 wt. % and ≦0.01 wt. %.

The fine particulate surfactant particles can comprise at least 2 wt. % to 26 wt. % surfactant, advantageously, 4 wt. % to 24 wt. % surfactant, preferably, 6 wt. % to 20 wt. % surfactant, and particularly preferably, 8 wt. % to 14 wt. % surfactant, based on the total weight of the fine particulate surfactant particles.

The fine particulate surfactant particles preferably comprise at least 10 wt. % to 40 wt. % sodium carbonate, advantageously, 15 wt. % to 38 wt. % sodium carbonate, preferably, 18 wt. % to 35 wt. % sodium carbonate, and particularly preferably, 20 wt. % to 30 wt. % sodium carbonate, based on the total weight of the fine particulate surfactant particles. However, lower amounts of sodium carbonate can be used, 11 wt. % to 25 wt. % sodium carbonate, and particularly preferably, 16 wt. % to 23 wt. % sodium carbonate, based on the total weight of the fine particulate surfactant particles, being used.

The fine particulate surfactant particles can also comprise at least 1 wt. % to 40 wt. % sodium hydrogen carbonate, advantageously, 10 wt. % to 35 wt. % sodium hydrogen carbonate, preferably, 15 wt. % to 30 wt. % sodium hydrogen carbonate, and particularly preferably, 18 wt. % to 25 wt. % sodium hydrogen carbonate, based on the total weight of the fine particulate surfactant particles. However, lower amounts of sodium hydrogen carbonate can also be used, preferably 2 wt. % to 8 wt. % sodium hydrogen carbonate, and particularly preferably, 5 wt. % to 6 wt. % sodium hydrogen carbonate, based on the total weight of the fine particulate surfactant particles, then being used.

The fine particulate surfactant particles can also comprise at least 1 wt. % to 50 wt. % sodium sulfate, advantageously, 15 wt. % to 40 wt. % sodium sulfate, preferably, 20 wt. % to 35 wt. % sodium sulfate, and particularly preferably, 25 wt. % to 30 wt. % sodium sulfate, based on the total weight of the fine particulate surfactant particles.

In preferred embodiments of the invention, the fine particulate surfactant particles consist of surfactant and at least one of the following salts: sodium carbonate, sodium hydrogen carbonate and/or sodium sulfate.

The fine particulate surfactant particles can comprise 10 wt. % to 24 wt. % surfactant, 10 wt. % to 25 wt. % sodium carbonate, 5 wt. % to 10 wt. % sodium hydrogen carbonate and 30 wt. % to 40 wt. % sodium sulfate, based on the total weight of the fine particulate surfactant particles, the respective weight proportions together making up maximum 100 wt. %.

In the context of the present invention, “d₅₀” is understood to mean that 50% of the particles have a smaller diameter and 50% of the particles have a larger diameter.

The particle diameter of the fine particulate surfactant particles d₅₀ preferably amounts to >0.05 mm and <0.6 mm, advantageously, ≧0.08 mm and ≦0.5 mm, and preferably ≧0.1 mm and ≦0.4 mm.

The fine particulate surfactant particles should have as uniform a particle size as possible in order to obtain a good solubility, free-flowability and/or good clumping test values. The fine particulate surfactant particles can have a shape factor of ≧0.5 and ≦0.8, advantageously ≧0.55 and ≦0.79, preferably >0.58, further preferably >0.6 and particularly preferably >0.65.

In the meaning of the present invention, the form factor (also known as shape factor) can be determined by means of modern particle measurement techniques with digital image processing. A typical suitable particle shape analysis as can be carried out for example with the Camsizer® system from Retsch Technology or also with the KeSizer® from the Kemira Company, involves irradiating the particles or the bulk material with a light source and recording, digitalizing and calculating the particles as the projection surfaces by means of a computer. The surface curvature is determined by an optical measurement technique, whereby the shadow, cast by the investigated parts, is measured and used to calculate the corresponding form factor. The form factor is measured based on the fundamental principle described, for example, by Gordon Rittenhouse in “A visual method of estimating two-dimensional sphericity” in the Journal of Sedimentary Petrology, Vol. 13, Nr. 2, pages 79-81. The measurement limits for this optical analytical method are 15 μm to 90 mm. The values for d₅₀ etc. can also be determined by this measurement technique.

Preferred embodiments of the fine particulate surfactant particles can have, for example, a bulk density of at least 300 g/l and maximum 700 g/l and preferably at least 400 g/l and maximum 500 g/l.

Moreover, the fine particulate surfactant particles can have a low fines content of ≧0% and ≦0.1% and advantageously ≧0.01% and ≦0.05%. Without being constrained by a particular theory, it is supposed that the lower fines content is due to the surfactant-controlled adhesive binding of the surfactant particle components.

Preferred fine particulate surfactant particles hold at least one, preferably a plurality of surfactants. The surfactant(s) can be selected from the group comprising anionic surfactants, cationic surfactants, amphoteric surfactants and/or non-ionic surfactants.

In the meaning of the present invention, discrete fine particulate surfactant particles are fine particulate surfactant particles that retain their fine particulate surfactant particle form as the fine particulate surfactant particle component of an essentially larger particle, for example, agglomerates, wherein these particles are particularly detergent- cleansing agent- and/or care product particles.

It has now been shown in an advantageous way that the fine particulate surfactant particles are present essentially as discrete, i.e., individual fine particulate surfactant particles as components of the inventive larger particles. These inventive particles comprise a mixture of compounds and discrete fine particulate surfactant particles advantageously as the primary and/or secondary surfactant particles.

Moreover, it is advantageous that the discrete fine particulate surfactant particles have no or practically no surfactant-controlled adhesive properties on their external surface, such that these individual fine particulate surfactant particles by themselves do not or practically not stick to other particle components of the larger particle. This results in a looser cohesion of discrete fine particulate surfactant particles inside the larger inventive particles.

The inventive particles hold, in addition to the fine particulate surfactant particles, a mixture of compounds preferably selected from at least one, preferably a plurality of components from the group comprising detergents, care and/or active cleansing substances, particularly anionic surfactants, cationic surfactants, amphoteric surfactants, non-ionic surfactants, builders, bleaching-agents, bleach activators, bleach stabilizers, bleach catalysts, enzymes, polymers, co-builders, alkalising agents, acidifiers, anti-redeposition agents, silver protection agents, colorants, optical brighteners, UV-protection agents, softeners, perfumes, foam inhibitors and/or rinse aids, as well as optional further ingredients.

The inventive particles preferably comprise the mixture of compounds and the fine particulate surfactant particles in proportions by weight of 1:10 to 10:1, advantageously 1:5 to 5:1, preferably 1:3 to 3:1 and particularly preferably, 1:2 to 2:1 and most preferably in the weight proportion 1:2.75.

The inventive particles, comprising a mixture of compounds and fine particulate surfactant particles, advantageously have a particle diameter d₅₀ of 0.1 mm-1.5 mm, preferably a particle diameter d₅₀ of 0.4 mm-1.2 mm and particularly preferably, a particle diameter d₅₀ of 0.8 mm-1.0 mm.

According to a preferred embodiment, the inventive particles can have a bulk density of 600 g/l to 800 g/l.

The inventive particles can have a free-flowability of at least 80%, particularly 90%, advantageously at least 95% and preferably 99% to ≦100%.

A particular advantage of the inventively preferred embodiments is when the inventive particles simultaneously have a good free-flowability in spite of the high bulk density. For particles known from the prior art, the bulk density is normally inversely proportional to the free-flowability, i.e., with increasing bulk density, the free-flowability decreases and vice versa. In contrast, the inventively preferred particles simultaneously have a good free-flowability in spite of the high bulk density.

According to a particularly preferred embodiment, the particles have a bulk density of 500 g/l to 1,200 g/l and preferably 600 g/l to 800 g/l and a free-flowability of at least 90%, advantageously at least 95% and preferably 99% to ≦100%.

It is also desirable that the particles have a low fines content. A low fines content ensures that contact between the consumer and the agent is reduced or even avoided, particularly when adding the detergent to the washing machine. However, a reduced propensity to dusting is also of importance for the manufacture of finished products as well as in connection with the dosage, storage and transport of such products. It is therefore preferred that the particles, for example, have a fines content of maximum 0.1%, preferably maximum 0.05% and particularly preferably, maximum 0.01%.

In the context of the present invention, fines (dust) is understood to mean particles with a particle size of 10 to 100 μm. The inventive particles can exhibit a good solubility. For example, at least ≧96 wt. %, preferably at least 97 wt. % of 1 g of particles dissolve within ≦90 seconds in 200 ml of tap water with a water hardness of 15° d and held at 10° C. Preferably, at least ≧96 wt. %, advantageously at least 97 wt. %, preferably at least 98 wt. % and particularly preferably, at least 99 wt. % of 1 g of particles dissolve within ≦90 seconds in 200 ml of tap water with a water hardness of 15° d and held at 30° C.

Inventively preferred particles can additionally have an improved residue limit. For example, 1 g of particles can have a residue limit in tap water with 15° d and held at 10° C. of ≧1% and ≦5%, advantageously ≧1.5% and ≦4.5%, preferably ≧2% and ≦4% and particularly preferably ≧2.5% and ≦3.5%.

Furthermore, it is inventively preferred when, for example, 1 g of particles have a residue limit in tap water with 15° d and held at 30° C. of ≧0% and ≦1%, advantageously ≧0.2% and ≦0.8%, preferably ≧0.4% and ≦0.7%, and particularly preferably ≧0.5% and ≦0.6%.

It is inventively preferred when at least ≧0 wt. % and ≦4 wt. %, advantageously ≧1 wt. % and ≦3.5 wt. % and preferably ≧2 wt. % and ≦3 wt. % of a residue forms from 1 g of particles in a dissolution time of 90 seconds in 200 ml of tap water with a water hardness of 15° d and held at 10° C., and/or ≧0 wt. % and ≦2 wt. %, advantageously ≧0.1 wt. % and ≦1.5 wt. % and preferably ≧0.5 wt. % and ≦1 wt. % of a residue forms from 1 g of particles in a dissolution time of 90 seconds in 200 ml of tap water with a water hardness of 15° d and held at 30° C.

In a preferred embodiment, the particles exhibit a dissolution time of maximum 90 seconds at a water temperature of 10° C. and/or a dissolution time of maximum 90 seconds at a water temperature of 30° C.

Due to the comprised fine particulate surfactant particles, the inventive particles exhibit very good clumping values. For example, in the clumping test, the inventive particles and/or the fine particulate surfactants have values of ≧0 g and ≦1 g, advantageously ≦0.5 g, preferably ≦0.2 g and particularly preferably ≦0.1 g.

For the inventive particles, the sedimentation test values can amount to ≧0 ml and ≦2 ml, advantageously ≧0.5 ml and ≦1.8 ml, preferably ≧1 ml and ≦1.6 ml and particularly preferably ≦1.5 ml.

The measurements of the residue limit, the clumping test and the sedimentation test are described below in the indicated measurement methods.

Advantageous embodiments of the inventive particles comprising a mixture of compounds and discrete fine particulate surfactant particles have, for example, the following particle size distribution:

wherein

≧0 to 5 wt. % of the particles have a particle diameter of <0.1 mm,
1 to 10 wt. % of the particles have a particle diameter of <0.2 mm to 0.1 mm,
50 to 70 wt. % of the particles have a particle diameter of <0.4 mm to 0.2 mm,
20 to 45 wt. % of the particles have a particle diameter of <0.8 mm to 0.4 mm,
≧0 to 5 wt. % of the particles have a particle diameter of <1.6 to 0.8 mm, based on the total weight of the particles, wherein each weight range is chosen such that together they total maximum 100 wt. %.

Further advantageous embodiments of the inventive particles comprising a mixture of compounds and discrete fine particulate surfactant particles have, for example, the following particle size distribution:

wherein
≧0 to 2 wt. % of the particles have a particle diameter of <0.1 mm,
1 to 8 wt. % of the particles have a particle diameter of <0.2 mm to 0.1 mm,
55 to 65 wt. % of the particles have a particle diameter of <0.4 mm to 0.2 mm,
25 to 40 wt. % of the particles have a particle diameter of <0.8 mm to 0.4 mm,
≧0 to 4 wt. % of the particles have a particle diameter of <1.6 to 0.8 mm, based on the total weight of the particles, wherein each weight range is chosen such that together they total maximum 100 wt. %.

Furthermore, advantageous embodiments of the inventive particles comprising a mixture of compounds and discrete fine particulate surfactant particles have, for example, the following particle size distribution:

wherein
≧0 to 1 wt. % of the particles have a particle diameter of <0.1 mm,
1 to 3 wt. % of the particles have a particle diameter of <0.2 mm to 0.1 mm,
60 to 65 wt. % of the particles have a particle diameter of <0.4 mm to 0.2 mm,
30 to 38 wt. % of the particles have a particle diameter of <0.8 mm to 0.4 mm,
≧0 to 2 wt. % of the particles have a particle diameter of <1.6 to 0.8 mm, based on the total weight of the particles, wherein each weight range is chosen such that together they total maximum 100 wt. %.

The proportion by weight of the fine particulate surfactant particles, based on the total weight of the inventive particles having a compound mixture and fine particulate surfactant particles, can amount to at least 10 wt. % to maximum 90 wt. %, advantageously 15 wt. % to 80 wt. %, preferably 20 wt. % to 70 wt. %, further preferably 30 wt. % to 40 wt. % and most preferably 34 wt. % to 38 wt. %.

The inventive particles can be post-treated with at least one component, wherein the quantity of components amounts to preferably up to 15 wt. %, particularly 2 to 15 wt. %, each based on the total weight of the agent comprising the post-treated particles.

Another subject matter of the present invention relates to a finished product, particularly detergent, cleansing agent or care product finished product, wherein the finished product holds at least 5 wt. % and maximum 100 wt. %, advantageously at least 30 wt. %, preferably at least 40 wt. %, further preferably at least 70 wt. %, even more preferably at least 90 wt. % and most preferably at least 95 wt. % particles according to one of claims 1 to 21 or particles according to one of claims 1 to 21 and fine particulate surfactant particles, based on the total weight of the finished product, wherein each weight range is chosen in such a way that together they amount to maximum 100 wt. %.

In a preferred embodiment, the finished product includes, in addition to the fine particulate surfactant particles and/or inventive particles, at least one, preferably a plurality of components selected from the group comprising anionic surfactants, cationic surfactants, amphoteric surfactants, non-ionic surfactants, builders, bleaching-agents, bleach activators, bleach stabilizers, bleach catalysts, enzymes, polymers, co-builders, alkalising agents, acidifiers, anti-redeposition agents, silver protection agents, colorants, optical brighteners, UV-protection agents, softeners, perfumes, foam inhibitors and/or rinse aids as the detergents, care and/or active cleansing substances, as well as optional further blended ingredients.

The inventive finished product can have particles, comprising a mixture of compounds and fine particulate surfactant particles, which preferably have a particle diameter d₅₀ of 0.1 mm-1.5 mm, advantageously a particle diameter d₅₀ of 0.4 mm-1.2 mm.

In the inventive finished product, the particles with fine particulate surfactant particles can have these at least partially as discrete surfactant particles, preferably as the primary and/or secondary surfactant particles.

Moreover, it is preferred when the inventive finished product has a bulk density of at least 400 g/l, advantageously 500 g/l to 1,200 g/l and preferably 600 g/l to 800 g/l.

In a preferred embodiment, the inventive finished product can exhibit a free-flowability of at least 90%, particularly 90%, advantageously at least 95% and preferably 99% to ≦100%.

A particularly preferred inventive embodiment of the finished product is when the finished product simultaneously also has a good free-flowability in spite of the high bulk density.

According to a particularly preferred inventive embodiment of the finished product, the product has a bulk density of 400 g/l, advantageously 500 g/l to 1,200 g/l and preferably 600 g/l to 800 g/l and a free-flowability of at least 90%, advantageously at least 95% and preferably 99% to ≦100%.

It is likewise desirable when the inventive finished product has, for example, a low fines content as this facilitates the handling and/or reduces a risk of contamination. It is therefore preferred that the finished product, for example, has a fines content of maximum 0 to 1%, preferably maximum 0.5% and particularly preferably maximum 0.06%.

The inventive finished product can exhibit a dissolution time of maximum 90 seconds at a water temperature of 10° C. and/or a dissolution time of maximum 90 seconds at a water temperature of 30° C.

Inventively preferred finished products can additionally have an improved residue limit. For example, 1 g of finished product can have a residue limit in tap water with 15° d and held at 10° C. of ≧1% and ≦5%, advantageously ≧1.5% and ≦4.5%, preferably ≧2% and ≦4% and particularly preferably ≧2.5% and ≦3.5%.

Furthermore, it is inventively preferred when, for example, 1 g of the finished product has a residue limit in tap water with 15° d and held at 30° C. of ≧0% and ≦1%, advantageously ≧0.2% and ≦0.8%, preferably ≧0.4% and ≦0.7%, and particularly preferably ≧0.5% and ≦0.6%.

Due to the comprised fine particulate surfactant particles, the inventive finished products exhibit very good clumping values. For example, in the clumping test, an inventive finished product has values of ≧0 g and ≦1 g, advantageously ≦0.5 g, preferably ≦0.2 g and particularly preferably ≦0.1 g.

For the inventive finished products, the sedimentation test values can amount to ≧0 ml and ≦2 ml, advantageously ≧0.5 ml and ≦1.8 ml, preferably ≧1 ml and ≦1.6 ml and particularly preferably ≦1.5 ml.

The measurements of the residue limit, the clumping test and the sedimentation test, are described below in the indicated measurement methods.

Advantageous, inventive finished products have, for example, the following particle size distribution:

wherein

≧0 to 5 wt. % of the particles have a particle diameter of <0.1 mm,
1 to 10 wt. % of the particles have a particle diameter of <0.2 mm to 0.1 mm,
50 to 70 wt. % of the particles have a particle diameter of <0.4 mm to 0.2 mm,
20 to 45 wt. % of the particles have a particle diameter of <0.8 mm to 0.4 mm,
≧0 to 5 wt. % of the particles have a particle diameter of <1.6 to 0.8 mm,
based on the total weight of the particles, wherein each weight range is chosen such that together they total maximum 100 wt. %.

Further preferred inventive finished products have, for example, the following particle size distribution:

wherein
≧0 to 2 wt. % of the particles have a particle diameter of <0.1 mm,
1 to 8 wt. % of the particles have a particle diameter of <0.2 mm to 0.1 mm,
55 to 65 wt. % of the particles have a particle diameter of <0.4 mm to 0.2 mm,
25 to 40 wt. % of the particles have a particle diameter of <0.8 mm to 0.4 mm,
≧0 to 4 wt. % of the particles have a particle diameter of <1.6 to 0.8 mm,
based on the total weight of the particles, wherein each weight range is chosen such that together they total maximum 100 wt. %.

Additionally preferred inventive finished products have, for example, the following particle size distribution:

wherein
≧0 to 1 wt. % of the particles have a particle diameter of <0.1 mm,
1 to 3 wt. % of the particles have a particle diameter of <0.2 mm to 0.1 mm,
60 to 65 wt. % of the particles have a particle diameter of <0.4 mm to 0.2 mm,
30 to 38 wt. % of the particles have a particle diameter of <0.8 mm to 0.4 mm,
≧0 to 2 wt. % of the particles have a particle diameter of <1.6 to 0.8 mm,
based on the total weight of the particles, wherein each weight range is chosen such that together they total maximum 100 wt. %.

Fine particulate surfactant particles, inventive particles, mixture of compounds and/or inventive finished product can comprise at least one, preferably a plurality, of components selected from the group comprising, in particular, anionic surfactants, cationic surfactants, amphoteric surfactants, non-ionic surfactants, builders, bleaching-agents, bleach activators, bleach stabilizers, bleach catalysts, enzymes, polymers, co-builders, alkalising agents, acidifiers, anti-redeposition agents, silver protection agents, colorants, optical brighteners, UV-protection agents, softeners, perfumes, foam inhibitors and/or rinse aids as the detergents, care and/or active cleansing substances, as well as optional further blended ingredients.

Exemplary suitable anionic surfactants are those of the sulfonate and sulfate type. Suitable surfactants of the sulfonate type are, advantageously C₉₋₁₃ alkylbenzene sulfonates, olefin sulfonates, i.e. mixtures of alkene- and hydroxyalkane sulfonates, and disulfonates, as are obtained, for example, from C₁₂₋₁₈ monoolefins having a terminal or internal double bond, by sulfonation with gaseous sulfur trioxide and subsequent alkaline or acidic hydrolysis of the sulfonation products. Those alkane sulfonates, obtained from C₁₂₋₁₈ alkanes by sulfochlorination or sulfoxidation, for example, with subsequent hydrolysis or neutralization, are also suitable. The esters of α-sulfofatty acids (ester sulfonates), e.g., the α-sulfonated methyl esters of hydrogenated coco-, palm nut- or tallow acid are likewise suitable.

Further suitable anionic surfactants are sulfated fatty acid esters of glycerine. They include the mono-, di- and triesters and also mixtures of them, such as those obtained by the esterification of a monoglycerin with 1 to 3 moles fatty acid or the transesterification of triglycerides with 0.3 to 2 moles glycerin. Preferred sulfated fatty acid esters of glycerol in this case are the sulfated products of saturated fatty acids with 6 to 22 carbon atoms, for example, caproic acid, caprylic acid, capric acid, myristic acid, lauric acid, palmitic acid, stearic acid or behenic acid.

Preferred alk(en)yl sulfates are the alkali and especially sodium salts of the sulfuric acid half-esters derived from the C₁₂-C₁₈ fatty alcohols, for example, from coconut butter alcohol, tallow alcohol, lauryl, myristyl, cetyl or stearyl alcohol or from C₁₀-C₂₀ oxo alcohols and those half-esters of secondary alcohols of these chain lengths. Additionally preferred are alk(en)yl sulfates of the said chain lengths, which contain a synthetic, straight-chained alkyl group produced on a petro-chemical basis, which show similar degradation behaviour to the suitable compounds based on fat chemical raw materials. The C₁₂-C₁₆ alkyl sulfates and C₁₂-C₁₅ alkyl sulfates and C₁₄-C₁₅ alkyl sulfates are preferred on the grounds of laundry performance. 2,3 Alkyl sulfates, which can be obtained from Shell Oil Company under the trade name DAN®, are also suitable anionic surfactants.

Sulfuric acid mono-esters derived from straight-chained or branched C₇₋₂₁ alcohols ethoxylated with 1 to 6 moles ethylene oxide are also suitable, for example, 2-methyl-branched C₉₋₁₁ alcohols with an average of 3.5 mole ethylene oxide (EO) or C₁₂₋₁₈ fatty alcohols with 1 to 4 EO. Due to their high foaming performance, they are only used in fairly small quantities in cleansing agents, for example, in amounts of 1 to 5% by weight.

Other suitable anionic surfactants are the salts of alkylsulfosuccinic acid, which are also referred to as sulfosuccinates or esters of sulfosuccinic acid and the monoesters and/or di-esters of sulfosuccinic acid with alcohols, preferably fatty alcohols and especially ethoxylated fatty alcohols. Preferred sulfosuccinates contain C₈₋₁₈ fatty alcohol groups or mixtures of them. Especially preferred sulfosuccinates contain a fatty alcohol residue derived from the ethoxylated fatty alcohols that are under consideration as non-ionic surfactants (see description below). Once again the especially preferred sulfosuccinates are those, whose fatty alcohol residues are derived from ethoxylated fatty alcohols with narrow range distribution. It is also possible to use alk(en)ylsuccinic acid with preferably 8 to 18 carbon atoms in the alk(en)yl chain, or salts thereof.

The content of the cited anionic surfactants is preferably 2 to 30 wt. % and particularly 5 to 25 wt. %, concentrations above 10 wt. % and even above 15 wt. % being particularly preferred.

Soaps can be comprised in addition to the cited anionic surfactants. Saturated fatty acid soaps are particularly suitable, such as the salts of lauric acid, myristic acid, palmitic acid, stearic acid, hydrogenated erucic acid and behenic acid, and especially soap mixtures derived from natural fatty acids such as coconut oil fatty acid, palm kernel oil fatty acid or tallow fatty acid. The content of soaps in the direct spray-dried products is preferably not more than 3 wt. % and particularly 0.5 to 2.5 wt. %.

The anionic surfactants and soaps may be present in the form of their sodium, potassium or ammonium salts or as soluble salts of organic bases, such as mono-, di- or triethanolamine. Preferably, they are in the form of their sodium or potassium salts, especially in the form of the sodium salt. Anionic surfactants and soaps can also be manufactured in situ, in that the anionic surfactant acids and optionally fatty acids are introduced into the spray-dryable composition, which are then neutralized in the spray-dryable composition by the alkalinity sources.

Non-ionic surfactants are usually—if at all—only present in minor amounts. For example, their content can range up to 2 or 3 wt. %. Reference can be made further below for a more detailed description of the non-ionic surfactants.

The fine particulate surfactant particles, particles and/or finished products can optionally also comprise cationic surfactants. Suitable cationic surfactants with antimicrobial action are, for example, surface-active quaternary compounds, in particular, with an ammonium, sulfonium, phosphonium, iodonium or arsonium group. By adding quaternary surface-active compounds with antimicrobial action, the fine particulate surfactant particles, the particles and/or the finished product can be furnished with an antimicrobial action or their existing antimicrobial action, resulting from the possible presence of other ingredients, can be improved.

Particularly preferred cationic surfactants are the quaternary, in some cases antimicrobially active ammonium compounds (QUATS; INCI Quaternary Ammonium Substances) according to the general formula (R^{I})(R^{II})(R^{III})(R^{IV})N⁺X⁻, in which R^{I} to R^{IV} may be the same or different C₁₋₂₂ alkyl groups, C₇₋₂₈ aralkyl groups or heterocyclic groups, wherein two or—in the case of an aromatic compound, such as pyridine—even three groups together with the nitrogen atom form the heterocycle, for example a pyridinium or imidazolinium compound, and X⁻ represents halide ions, sulfate ions, hydroxide ions or similar anions. In the interests of optimal antimicrobial activity, at least one of the substituents preferably has a chain length of 8 to 18 and, more preferably, 12 to 16 carbon atoms.

QUATS can be obtained by reacting tertiary amines with alkylating agents such as, for example, methyl chloride, benzyl chloride, dimethyl sulfate, dodecyl bromide but also ethylene oxide. The alkylation of tertiary amines having one long alkyl chain and two methyl groups is particularly easy. The quaternization of tertiary amines containing two long chains and one methyl group can also be carried out under mild conditions using methyl chloride. Amines containing three long alkyl chains or hydroxy-substituted alkyl chains lack reactivity and are preferably quaternized with dimethyl sulfate.

Suitable QUATS are, for example, benzalkonium chloride (N-alkyl-N,N-dimethylbenzyl ammonium chloride, CAS No. 8001-54-5), benzalkon B (m,p-dichlorobenzyl dimethyl-C₁₋₂ alkyl ammonium chloride, CAS No. 58390-78-6), benzoxonium chloride (benzyldodecyl-bis-(2-hydroxyethyl) ammonium chloride), cetrimonium bromide (N-hexadecyl-N,N-trimethyl ammonium bromide, CAS No. 57-09-0), benzetonium chloride (N,N-di-methyl-N-[2-[2-[p-(1,1,3,3-tetramethylbutyl)-phenoxy]ethoxy]-ethyl]-benzyl ammonium chloride, CAS No. 121-54-0), dialkyl dimethyl ammonium chlorides, such as di-n-decyldimethyl ammonium chloride (CAS No. 7173-51-5-5), didecyldimethyl ammonium bromide (CAS No. 2390-68-3), dioctyl dimethyl ammonium chloride, 1-cetylpyridinium chloride (CAS No. 123-03-5) and thiazoline iodide (CAS No. 15764-48-1) and mixtures thereof. Preferred QUATS are the benzalkonium chlorides containing C₈₋₁₈ alkyl groups, more particularly C₁₂₋₁₄ alkyl benzyl dimethyl ammonium chloride. A particularly preferred QUAT is cocopentaethoxy methyl ammonium methosulfate (INCI PEG-5 Cocomonium Methosulfate; Rewoquate CPEM).

To avoid possible incompatibilities of the antimicrobial cationic surfactants with the inventively comprised anionic surfactants, cationic surfactants that are most compatible possible with anionic surfactants and/or the least possible cationic surfactant are employed; or, in a particular embodiment of the invention, antimicrobially active cationic surfactants are dispensed with altogether. Parabens, benzoic acid and/or benzoates, lactic acid and/or lactates can be added as the antimicrobially active substances. Benzoic acid and/or lactic acid are particularly preferred.

The fine particulate surfactant particles, particles and/or finished product can comprise one or more cationic surfactants in amounts, based on the total composition, of 0 to 5 wt. %, greater than 0 to 5 wt. %, preferably 0.01 to 3 wt. %, particularly 0.1 to 1 wt. %.

Likewise, the fine particulate surfactant particles, particles and/or finished product can also comprise amphoteric surfactants. Suitable amphoteric surfactants are, for example, betaines of the Formula (R¹)(R²)(R³)N⁺CH₂CO⁻, in which R¹ means an alkyl group with 8 to 25, preferably 10 to 21 carbon atoms, optionally interrupted by heteroatoms or heteroatomic groups, and R² and R³ mean the same or different alkyl groups with 1 to 3 carbon atoms, in particular, C₁₀-C₂₂ alkyldimethylcarboxymethylbetaine and C₁₁-C₁₇ alkylamidopropyldimethylcarboxymethylbetaine. Furthermore, the addition of alkylamido alkylamines, alkyl substituted amino acids, acylated amino acids or biosurfactants as the amphoteric surfactants into the fine particulate surfactant particles, particles and/or finished product is conceivable.

The fine particulate surfactant particles, particles and/or finished product can comprise one or more amphoteric surfactants in amounts, based on the total composition, of 0 to 5 wt. %, greater than 0 to 5 wt. %, preferably 0.01 to 3 wt. %, particularly 0.1 to 1 wt. %.

Further ingredients of the fine particulate surfactant particles, particles and/or finished product can be inorganic and optionally organic builders. The inorganic builders also include non-water-insoluble ingredients such as aluminosilicates and particularly zeolites. Of the suitable fine crystalline, synthetic zeolites containing bound water, zeolite A and/or P are preferred. A particularly preferred zeolite P is zeolite MAP® (a commercial product of Crosfield). However, zeolite X and mixtures of A, X, Y and/or P are also suitable. A co-crystallized sodium/potassium aluminum silicate from Zeolite A and Zeolite X, which is available as VEGOBOND AX® (commercial product from Condea Augusta S.p.A.), is also of particular interest. This product is described in more detail below. The zeolite can be employed as the spray-dried powder or also as the non-dried, still moist from its manufacture, stabilized suspension. For the case where the zeolite is added as a suspension, this can comprise small amounts of non-ionic surfactants as stabilizers, for example 1 to 3 wt. %, based on the zeolite, of ethoxylated C₁₂-C₁₈ fatty alcohols with 2 to 5 ethylene oxide groups, C₁₂-C₁₄ fatty alcohols with 4 to 5 ethylene oxide groups or ethoxylated isotridecanols. Suitable zeolites have an average particle size of less than 10 μm (test method: volumetric distribution). Coulter counter) and preferably comprise 18 to 22 wt. %, particularly 20 to 22 wt. % of bound water.

Further particularly preferred suitable zeolites are zeolites of the Faujasite type. The mineral Faujasite, together with the zeolites X and Y, belongs to the Faujasite types in the zeolite structural group 4, which are characterized by the double six-membered ring sub unit D6R. The zeolite structural group 4 also includes, in addition to the mentioned Faujasite types, the minerals Chabazite and Gmelinite as well as the synthetic zeolite R (Chabazite type), S (Gmelinite type), L and ZK-5. Both of the last mentioned synthetic zeolites have no mineral analogs.

Zeolites of the Faujasite type are built up from β-cages that are linked through D6R sub units, wherein the β-cages are arranged similarly to the carbon atoms in diamond. The three dimensional network of the inventively suitable zeolites of the Faujasite type have pores of 2.2 and 7.4 Å, the unit cell moreover comprises 8 cavities with ca. 13 Å diameter and can be described by the formula Na₈₆[(AlO₂)₈₆(SiO₂)₁₀₆].264H₂O. The network of the zeolite X comprises a pore space of about 50%, based on the dehydrated crystal, representing the largest pore space of all known zeolites (zeolite Y: ca. 48% pore space, Faujasite: ca. 47% pore space).

In the context of the present invention, the term “zeolite of the Faujasite type” denotes all three zeolites that form the Faujasite sub group of the zeolite structural group 4. Other than the zeolite X, zeolite Y and Faujasite as well as mixtures of these compounds are inventively suitable, pure zeolite X being preferred.

Mixtures or cocrystallizates of zeolites of the Faujasite type with other zeolites that do not necessarily belong to the zeolite structural group 4 are inventively suitable, wherein preferably at least 50 wt. % of the zeolites are zeolites of the Faujasite type.

The suitable aluminum silicates are commercially available and their methods of preparation are described in standard monographs.

Examples of commercially available zeolites of the X type can be described by the following formulas:
Na₈₆[(AlO₂)₈₆(SiO₂)₁₀₆].xH₂O,
K₈₆[(AlO₂)₈₆(SiO₂)₁₀₆].xH₂O,
Ca₄₀Na₆[(AlO₂)₈₆(SiO₂)₁₀₆].xH₂O,
Sr₂₁Ba₂₂[(AlO₂)₈₆(SiO₂)₁₀₆].xH₂O,
in which x can assume values of greater than 0 to 276. These zeolites have pore sizes of 8.0 to 8.4 Å.

Zeolite A-LSX is also suitable, for example, corresponding to a cocrystallizate of zeolite X and zeolite A and having in its anhydrous form the formula (M_{2/n}O+M′_{2/n}O).Al₂O₃.zSiO₂, wherein M and M′ can be alkali or alkaline earth metals and z is a number from 2.1 to 2.6. This product is commercially available under the trade name VEGOBOND AX from the company CONDEA Augusta S.p.A.

Zeolites of the Y type are also commercially available and can be described by the formulas
Na₅₆[(AlO₂)₅₆(SiO₂)₁₃₆].xH₂O,
K₅₆[(AlO₂)₅₆(SiO₂)₁₃₆].xH₂O,
in which x stands for numbers greater than 0 to 276. These zeolites have pore sizes of 8.0 Å.

The particle sizes of the suitable zeolites of the Faujasite type are in the range 0.1 μm to 100 μm, preferably 0.5 μm to 50 μm, and particularly 1 μm to 30 μm, each measured by standard particle size determination methods.

In another basic embodiment of the invention, however, the comprised inorganic ingredients should be water-soluble. Consequently, in this embodiment, other builders than the cited zeolites are employed.

In cases where a phosphate content is tolerated, phosphates can also be jointly used, in particular, pentasodium phosphate, optionally also pyrophosphates as well as orthophosphates, which are primarily used to precipitate lime scale salts. Phosphates are predominantly used in automatic dishwashers, but also to some extent still in detergents.

“Alkali metal phosphates” is the collective term for the alkali metal (more particularly sodium and potassium) salts of the various phosphoric acids, in which metaphosphoric acids (HPO₃)ₙ and orthophosphoric acid (H₃PO₄) and representatives of higher molecular weight can be differentiated. The phosphates combine several inherent advantages: they act as alkalinity sources, prevent lime scale deposits on machine parts and lime incrustations in fabrics and, in addition, contribute towards the cleansing power.

Sodium dihydrogen phosphate NaH₂PO₄ exists as the dihydrate (density 1.91 gcm⁻³, melting point 60° C.) and as the monohydrate (density 2.04 gcm⁻³). Both salts are white, readily water-soluble powders that on heating, lose the water of crystallization and at 200° C. are converted into the weakly acidic diphosphate (disodium hydrogen diphosphate, Na₂H₂P₂O₇) and, at higher temperatures into sodium trimetaphosphate (Na₃P₃O₉) and Maddrell's salt (see below). NaH₂PO₄ shows an acidic reaction. It is formed by adjusting phosphoric acid with sodium hydroxide to a pH value of 4.5 and spraying the resulting “mash.” Potassium dihydrogen phosphate (primary or monobasic potassium phosphate, potassium biphosphate, KDP), KH₂PO₄, is a white salt with a density of 2.33 gcm⁻³, has a melting point of 253° C. [decomposition with formation of potassium polyphosphate (KPO₃)ₓ] and is readily soluble in water.

Disodium hydrogen phosphate (secondary sodium phosphate), Na₂HPO₄, is a colorless, very readily water-soluble crystalline salt. It exists in anhydrous form and with 2 mol (density 2.066 gcm⁻³, water loss at 95° C.), 7 mol (density 1.68 gcm⁻³, melting point 48° with loss of 5H₂O) and 12 mol of water (density 1.52 gcm⁻³, melting point 350 with loss of 5H₂O), becomes anhydrous at 1000 and, on fairly intensive heating, is converted into the diphosphate Na₄P₂O₇. Disodium hydrogen phosphate is prepared by neutralization of phosphoric acid with soda solution using phenolphthalein as the indicator. Dipotassium hydrogen phosphate (secondary or dibasic potassium phosphate), K₂HPO₄, is an amorphous white salt, which is readily soluble in water.

Trisodium phosphate, tertiary sodium phosphate, Na₃PO₄, are colorless crystals with a density of 1.62 gcm⁻³ and a melting point of 73-76° C. (decomposition) as the dodecahydrate; as the decahydrate (corresponding to 19-20% P₂O₅) a melting point of 100° C., and in anhydrous form (corresponding to 39-40% P₂O₅) a density of 2.536 gcm⁻³. Trisodium phosphate is readily soluble in water through an alkaline reaction and is prepared by concentrating a solution of exactly 1 mole of disodium phosphate and 1 mole of NaOH by evaporation. Tripotassium phosphate (tertiary or tribasic potassium phosphate), K₃PO₄, is a white deliquescent granular powder with a density of 2.56 gcm⁻³, has a melting point of 1,340° C. and is readily soluble in water through an alkaline reaction. It is formed, for example, when Thomas slag is heated with coal and potassium sulfate. Despite their higher price, the more readily soluble and therefore highly effective potassium phosphates are often preferred to corresponding sodium compounds in the detergent industry.

Tetrasodium diphosphate (sodium pyrophosphate), Na₄P₂O₇, exists in anhydrous form (density 2.534 gcm⁻³, melting point 988° C., a figure of 880° C. has also been mentioned) and as the decahydrate (density 1.815-1.836 gcm³, melting point 94° C. with loss of water). Both substances are colorless crystals, which dissolve in water through an alkaline reaction. Na₄P₂O₇ is formed when disodium phosphate is heated to more than 200° C. or by reacting phosphoric acid with soda in a stoichiometric ratio and spray-drying the solution. The decahydrate complexes heavy metal salts and hardness salts and, hence, reduces the hardness of water. Potassium diphosphate (potassium pyrophosphate), K₄P₂O₇, exists in the form of the trihydrate and is a colorless hygroscopic powder with a density of 2.33 gcm⁻³, which is soluble in water, the pH of a 1% solution at 25° C. being 10.4.

Relatively high molecular weight sodium and potassium phosphates are formed by condensation of NaH₂PO₄ or KH₂PO₄. They may be divided into cyclic types, namely the sodium and potassium metaphosphates, and chain types, the sodium and potassium polyphosphates. The chain types, in particular, are known by various different names: fused or calcined phosphates, Graham's salt, Kurrol's salt and Maddrell's salt. All higher sodium and potassium phosphates are known collectively as condensed phosphates.

The industrially important pentasodium triphosphate, Na₅P₃O₁₀ (sodium tripolyphosphate), is anhydrous or crystallizes with 6H₂O to a non-hygroscopic white water-soluble salt that has the general formula NaO—[P(O)(ONa)—O]ₙ—Na where n=3. Around 17 g of the salt free from water of crystallization dissolve in 100 g of water at room temperature, around 20 g at 60° C. and around 32 g at 100° C. After heating the solution for 2 hours to 100° C., around 8% orthophosphate and 15% diphosphate are formed by hydrolysis. In the preparation of pentasodium triphosphate, phosphoric acid is reacted with soda solution or sodium hydroxide in a stoichiometric ratio and the solution is spray-dried. Similarly to Graham's salt and sodium diphosphate, pentasodium triphosphate dissolves many insoluble metal compounds (including lime soaps, etc.). Pentapotassium triphosphate, K₅P₃O₁₀ (potassium tripolyphosphate), is marketed for example in the form of a 50% by weight solution (>23% P₂O₅, 25% K₂O). The potassium polyphosphates are widely used in the detergent industry. Sodium potassium tripolyphosphates also exist and are also usable in the scope of the present invention. They are formed, for example, when sodium trimetaphosphate is hydrolyzed with KOH:
(NaPO₃)₃+2KOH→Na₃K₂P₃O₁₀+H₂O

According to the invention, they may be used in exactly the same way as sodium tripolyphosphate, potassium tripolyphosphate or mixtures thereof. Mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate may also be used in accordance with the invention. However, in a preferred embodiment of the invention, particularly carbonates and silicates are used as the inorganic builders.

Suitable silicate builders are the crystalline, layered sodium silicates corresponding to the general formula NaMSiₓO₂ₓ₊₁yH₂O, wherein M is sodium or hydrogen, x is a number from 1.6 to 4, preferably 1.9 to 4.0 and y is a number from 0 to 20, preferred values for x being 2, 3 or 4. As these types of crystalline silicates lose at least partially their crystalline structure in a spray-drying process, crystalline silicates are preferably subsequently blended with the direct or post-treated spray-dried product. Preferred crystalline layered silicates of the given formula are those in which M stands for sodium and x assumes the values 2 or 3. Both β- and δ-sodium disilicates Na₂Si₂O₅ yH₂O are preferred. These types of compounds are commercially available, for example, under the designation SKS® (Clariant). SKS-6® is predominantly a δ-sodium disilicate with the formula Na₂Si₂O₅ yH₂O, SKS-7® is predominantly a β-sodium silicate. On reaction with acids (e.g. citric acid or carbonic acid), δ-sodium disilicate yields Kanemite NaHSi₂O₅yH₂O, which is commercially available under the designations SKS-9® and SKS-10® from Clariant. It can also be advantageous to chemically modify these layered silicates. The alkalinity, for example, of the layered silicates can be suitably modified. In comparison with the 6-sodium disilicate, layered silicates, doped with phosphate or carbonate, exhibit a different crystal morphology, dissolve more rapidly and show an increased calcium binding ability. Examples are layered silicates of the general formula xNa₂O.ySiO₂.zP₂O₅ in which the ratio x to y corresponds to a number 0.35 to 0.6, the ratio x to z a number from 1.75 to 1,200 and the ratio y to z a number from 4 to 2,800. The solubility of the layered silicates can also be increased by employing particularly finely divided layered silicates. Substances from the crystalline layered silicates can also be used with other ingredients. In particular, substances with cellulose derivatives that exhibit an advantage in the disintegration action, as well as substances with polycarboxylates, e.g. citric acid, or polymeric carboxylates, e.g. copolymers of acrylic acid may be cited.

Preferred builders include amorphous sodium silicates with a modulus (Na₂O:SiO₂ ratio) of 1:2 to 1:3.3, preferably 1:2 to 1:2.8 and more preferably 1:2 to 1:2.6, which exhibit secondary wash cycle properties. In the context of this invention, the term “amorphous” also means “X-ray amorphous.” In other words, the silicates do not produce any of the sharp X-ray reflections typical of crystalline substances, but at best one or more maxima of the scattered X-radiation, which have a width of several degrees of the diffraction angle. However, particularly good builder properties may even be achieved where the silicate particles produce indistinct or even sharp diffraction maxima in electron diffraction experiments. This is interpreted to mean that the products have microcrystalline regions between 10 and a few hundred nm in size, values of up to at most 50 nm and especially up to at most 20 nm being preferred. Compacted/densified amorphous silicates, compounded amorphous silicates and over dried X-ray-amorphous silicates are particularly preferred. The content of the (X-ray) amorphous silicates in the zeolite-free direct spray-dried products is preferably 1 to 10 wt. %.

However, particularly preferred inorganic water-soluble builders are alkali metal carbonates and alkali metal bicarbonates, sodium and potassium carbonate and particularly sodium carbonate being among the preferred embodiments. The alkali metal carbonate content in the particularly zeolite-free direct spray-dried products can vary over a wide range and is preferably 5 to 40 wt. %, particularly 8 to 30 wt. %, wherein the content of the alkali metal carbonates is higher than that of (X-ray) amorphous silicates.

Useful organic builders are, for example, the polycarboxylic acids usable in the form of their alkaline and especially sodium salts, such as citric acid, adipic acid, succinic acid, glutaric acid, tartaric acid, sugar acids, aminocarboxylic acids, nitrilotriacetic acid (NTA), providing its use is not ecologically unsafe, and mixtures thereof. Preferred salts are the salts of polycarboxylic acids such as citric acid, adipic acid, succinic acid, glutaric acid, tartaric acid, sugar acids and mixtures thereof.

Other organic builders are polymeric polycarboxylates, i.e., for example, the alkali metal salts of polyacrylic or polymethacrylic acid, for example, those with a relative molecular weight of 500 to 70,000 g/mol. The molecular weights mentioned in this specification for polymeric polycarboxylates are weight-average molecular weights M_{w} of the particular acid form which, fundamentally, were determined by gel permeation chromatography (GPC), equipped with a UV detector. The measurement was carried out against an external polyacrylic acid standard, which provides realistic molecular weight values by virtue of its structural similarity to the polymers investigated. These values differ significantly from the molecular weights measured against polystyrene sulfonic acids as standard. The molecular weights measured against polystyrene sulfonic acids are generally significantly higher than the molecular weights mentioned in this specification.

Particularly suitable polymers are polyacrylates, which preferably have a molecular weight of 2,000 to 20,000 g/mol. By virtue of their superior solubility, preferred representatives of this group are again the short-chain polyacrylates, which have molecular weights of 2,000 to 10,000 g/mol and, more particularly, 3,000 to 5,000 g/mol.

Further suitable copolymeric polycarboxylates are particularly those of acrylic acid with methacrylic acid and of acrylic acid or methacrylic acid with maleic acid. Copolymers of acrylic acid with maleic acid, which comprise 50 to 90 wt. % acrylic acid and 50 to 10 wt. % maleic acid, have proven to be particularly suitable. Their relative molecular weight, based on free acids, generally ranges from 2,000 to 70,000 g/mol, preferably 20,000 to 50,000 g/mol and especially 30,000 to 40,000 g/mol.

The content of organic builders in the fine particulate surfactant particles, particles and/or finished product can also vary over a wide range. Contents of 2 to 20 wt. % are preferred, contents of maximum 10 wt. % being particularly of interest, mainly on the grounds of cost.

From the remaining groups of conventional detergent ingredients, in particular, components from the classes of graying inhibitors, neutral salts and fabric softeners can be considered for use in the fine particulate surfactant particles, particles and/or finished product.

Graying inhibitors have the function of maintaining the dirt that was removed from the fibers suspended in the washing liquor, thereby preventing the dirt from resettling. Water-soluble colloids of mostly organic nature are suitable for this, for example, the water-soluble salts of polymeric carboxylic acids, glue, gelatins, salts of ether carboxylic acids or ether sulfonic acids of starches or celluloses, or salts of acidic sulfuric acid esters of celluloses or starches. Water-soluble, acid group-containing polyamides are also suitable for this purpose. Moreover, soluble starch preparations and others can be used as the above-mentioned starch products, e.g. degraded starches, aldehyde starches etc. Polyvinyl pyrrolidone can also be used. Preference, however, is given to the use of cellulose ethers such as carboxymethyl cellulose (Na salt), methyl cellulose, hydroxyalkyl celluloses, and mixed ethers such as methyl hydroxyethyl cellulose, methyl hydroxypropyl cellulose, methyl carboxymethyl cellulose and mixtures thereof, as well as polyvinyl pyrrolidone, which can be added, for example, in amounts of 0.1 to 5 wt. %, based on the total weight of the fine particulate surfactant particles, particles and/or finished product.

A typical example of a suitable representative neutral salt is the already discussed sodium sulfate. For example, amounts of 2 to 45 wt. % can be added.

Suitable softeners are, for example, swellable, layered silicates of the type corresponding to montmorillonite, for example, bentonite.

The water content in the fine particulate surfactant particles, particles and/or finished product preferably ranges from 0 to less than 10 wt. % and particularly 0.5 to 8 wt. %, values of up to 5 wt. % being particularly preferred. The water, eventually adhering to the aluminosilicates such as zeolites, is not counted in this figure.

The particles of the inventive finished product can be subjected to a post-treatment, for example, rounding the particles of the direct spray-dried product. Rounding the direct spray-dried product can be carried out in a conventional spheronizer. Preferably, the rounding time is not more than 4 minutes, in particular, not more than 3.5 minutes. Rounding times of maximum 1.5 minutes or less are particularly preferred. A further uniformization of the particle size distribution results from the rounding as any eventual larger particles are reduced in size.

Prior to the rounding step, the inventive finished product can be treated using a conventional process, preferably in a mixer or optionally a fluidized bed, with non-ionic surfactants, perfumes and/or foam inhibitors or preparation forms that comprise these ingredients, preferably in amounts of up to 20 wt. % active substance, particularly in amounts of 2 up to 18 wt. % active substance, each based on the treated product.

In particular, the inventive particles and/or finished product can be subsequently post-treated with solids, preferably in amounts of up to 15 wt. %, particularly in amounts of 2 to 15 wt. %, each based on the total weight of the treated finished product.

Preferably, bicarbonate, carbonate, zeolite, silica, citrate, urea or their mixtures can be used as the solids, particularly in amounts of 2 to 15 wt. %, based on the total weight of the treated product. The post-treatment can be advantageously carried out in a mixer and/or by means of a spheronizer.

In the post-treatment step, it is therefore possible to apply powder to the inventive particles with a solid, for example silicas, zeolites, carbonates, bicarbonates and/or sulfates, citrates, urea or their mixtures, as is well known from the prior art. For this, it is preferred to add solids, in particular, bicarbonate and soda in amounts of up to 15 wt. % and particularly in amounts of 2 to 15 wt. %, each based on the treated product.

In a preferred embodiment of the invention, the finished product is post-treated with non-ionic surfactants that can comprise for example optical brighteners and/or hydrotropes, perfume, a solution of optical brightener and/or foam inhibitors or preparation forms that can comprise these ingredients. Preferably, these ingredients or preparation forms that comprise these ingredients are deposited in liquid, molten or paste form onto the particles of the finished product.

Advantageously, the particles of the inventive finished product are post-treated with up to 20 wt. %, advantageously with 2 to 18 wt. % and particularly with 5 to 15 wt. % active substance of the cited ingredients. The quantities are each based on the post-treated product. The post-treatment with the above-mentioned substances is preferably carried out in a conventional mixer, for example in a twin-shaft mixer for maximum 1 minute, preferably within 30 seconds and, for example, within 20 seconds, the times standing simultaneously for addition time and mixing time.

Preferred non-ionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain linear and methyl-branched groups in the form of the mixtures typically present in oxoalcohol groups. Particularly preferred, however, are alcohol ethoxylates with linear alcohols of natural origin with 12 to 18 carbon atoms, e.g. from coco-, palm-, palm nut-, tallow- or oleyl alcohol, and an average of 2 to 8 EO per mol alcohol. Exemplary preferred ethoxylated alcohols include C₁₂₋₁₄ alcohols with 3 EO or 4EO, C₉-C₁₁ alcohols with 7 EO, C₁₃-C₁₅ alcohols with 3 EO, 5 EO, 7 EO or 8 EO, C₁₂-C₁₈ alcohols with 3 EO, 5 EO or 7 EO and mixtures thereof, such as mixtures of C₁₂-C₁₄ alcohols with 3 EO and C₁₂-C₁₈ alcohols with 7 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are (tallow) fatty alcohols with 14 EO, 16 EO, 20 EO, 25 EO, 30 EO or 40 EO.

Furthermore, as additional non-ionic surfactants, alkyl glycosides that satisfy the general Formula RO(G)ₓ can be added, where R means a primary linear or methyl-branched, particularly 2-methyl-branched, aliphatic group containing 8 to 22 and preferably 12 to 18 carbon atoms and G stands for a glycose unit containing 5 or 6 carbon atoms, preferably glucose. The degree of oligomerization x, which defines the distribution of monoglycosides and oligoglycosides, is any number from 1 to 10, preferably from 1.1 to 1.4.

Another class of preferred non-ionic surfactants which may be used, either as the sole non-ionic surfactant or in combination with other non-ionic surfactants, in particular, together with alkoxylated fatty alcohols and/or alkyl glycosides, are alkoxylated, preferably ethoxylated or ethoxylated and propoxylated fatty acid alkyl esters preferably containing 1 to 4 carbon atoms in the alkyl chain, in particular, fatty acid methyl esters. C₁₂-C₁₈ fatty acid methyl esters containing an average of 3 to 15 EO, particularly containing an average of 5 to 12 EO, are particularly preferred.

Non-ionic surfactants of the amine oxide type, for example, N-cocoalkyl-N,N-dimethylamine oxide and N-tallow alkyl-N,N-dihydroxyethylamine oxide, and the fatty acid alkanolamides may also be suitable. The quantity in which these non-ionic surfactants are used is preferably no more than the quantity in which the ethoxylated fatty alcohols are used and, particularly no more than half that quantity.

For automatic dishwashers, the surfactants include in principle all surfactants that do not foam or at best weakly foam. The above-mentioned non-ionic surfactants, above all the low foaming non-ionic surfactants, are preferred for this application. Alkoxylated alcohols, particularly the ethoxylated and/or propoxylated alcohols are particularly preferred. Alkoxylated alcohols are generally understood by the person skilled in the art to mean the reaction products of alkylene oxide, preferably ethylene oxide, with alcohols, preferably the long chain alcohols in the context of the present invention, (C₁₀ to C₁₈, preferably C₁₂ to C₁₆, such as, for example C₁₁, C₁₂, C₁₃, C₁₄, C₁₅, C₁₆, C₁₇ and C₁₈ alcohols). As a rule, n moles of ethylene oxide react with one mole of alcohol to form, depending on the reaction conditions, a complex mixture of addition products with different degrees of ethoxylation. A further embodiment consists in the use of mixtures of alkylene oxides, preferably the mixture of ethylene oxide and propylene oxide. If desired, the substance class of end-blocked (“capped”) can be produced by a subsequent etherification with short chain alkyl groups, preferably the butyl group, and can also be used in the context of the invention. In the context of the present invention, highly ethoxylated fatty alcohols or their mixtures with end-blocked ethoxylated fatty alcohols are quite particularly preferred.

Suitable perfume oils or fragrances include individual perfume compounds, for example synthetic products of the ester, ether, aldehyde, ketone, alcohol and hydrocarbon type. Perfume compounds of the ester type are, for example, benzyl acetate, phenoxyethyl isobutyrate, p-tert.-butylcyclohexyl acetate, linalyl acetate, dimethylbenzyl carbinyl acetate, phenylethyl acetate, linalyl benzoate, benzyl formate, ethylmethylphenyl glycinate, allylcyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyloxyacetaldehyde, cyclamen aldehyde, hydroxycitronellal, lilial and bourgeonal; the ketones include, for example, the ionones, α-isomethyl ionone and methyl cedryl ketone; the alcohols include anethol, citronellol, eugenol, geraniol, linalool, phenylethyl alcohol and terpineol and the hydrocarbons include, above all, the terpenes, such as limonene and pinene. However, mixtures of various odoriferous substances, which together produce an attractive perfume note, are preferably used. Perfume oils such as these may also contain natural perfume mixtures obtainable from vegetal sources, for example, pine, citrus, jasmine, patchouli, rose or ylang ylang oil. Also suitable are muscatel oil, oil of sage, chamomile oil, clove oil, melissa oil, mint oil, cinnamon leaf oil, lime blossom oil, juniper berry oil, vetivert oil, olibanum oil, galbanum oil and ladanum oil and orange blossom oil, neroli oil, orange peel oil and sandalwood oil.

Further possible additives are foam inhibitors, for example, foam inhibiting paraffin oil or foam inhibiting silicone oil, for example polydimethylsiloxane. Mixtures of these active substances can also be added. The room temperature solid additives include, particularly for the cited foam inhibiting active substances, paraffin waxes, silicas that can also be hydrophobized by known methods, and bis-amides derived from C₂₋₇ diamines and C₁₂₋₂₂ carboxylic acids.

For the foam inhibiting paraffin oils that could be added, which can be present in a mixture with paraffin waxes, in general the mixtures of substances do not have sharp melting points. They are usually characterized by measuring the melting range by means of differential thermoanalysis (DTA) and/or from the solidification point. This is understood to mean the temperature at which the paraffin goes from the liquid state to the solid state on slow cooling. Paraffins with less than 17 carbon atoms are not usable according to the invention; their content in the paraffin oil mixture should accordingly be as low as possible and preferably be below the significant detection limits of conventional analytical methods, for example gas chromatography. Preferably, paraffins that solidify in the range 20° C. to 70° C. are used. In this context it should be noted that paraffin wax mixtures that are solid at room temperature, might also comprise different contents of liquid paraffin oils. For the inventively usable paraffin waxes, the liquid content at 40° C. is as high as possible, without being 100% already at this temperature. Preferred paraffin wax mixtures have a liquid content at 40° C. of at least 50 wt. %, particularly 55 wt. % to 80 wt. %, and a liquid content at 60° C. of at least 90 wt. %. In consequence, the paraffins are able to flow and are pumpable at temperatures down to at least 70° C., preferably down to at least 60° C. Furthermore, care must be taken to ensure that the paraffins comprise the lowest possible volatile content. Preferred paraffin waxes comprise less than 1 wt. %, particularly less than 0.5 wt. % volatiles at 110° C. under normal pressure. Inventively usable paraffins can be obtained for example under the trade names Lunaflex® from the Fuller Company and Deawax® from DEA Mineralol AG.

The paraffin oils can comprise room temperature-solid bisamides that derive from saturated fatty acids containing 12 to 22, preferably 14 to 18 carbon atoms, and alkylenediamines containing 2 to 7 carbon atoms. Suitable fatty acids are lauric, myristic, stearic, arachidic and behenic acid as well as their mixtures as are obtained from natural fats or from hydrogenated oils such as tallow or hydrogenated palm oil. Suitable diamines are for example ethylenediamine, 1,3-propylenediamine, tetramethylenediamine, pentamethylenediamine, hexamethylenediamine, p-phenylenediamine and toluylenediamine. Preferred diamines are ethylenediamine and hexamethylenediamine. Particularly preferred bisamides are bis-myristoyl ethylenediamine, bispalmitoyl ethylenediamine, bis-stearoyl ethylenediamine and their mixtures as well as the corresponding hexamethylenediamine derivatives.

In some embodiments of the invention, the cited foam inhibitors can also be comprised in the fine particulate surfactant particles and/or particles.

In a further embodiment of the invention, the optionally rounded product, post-treated with the mentioned ingredients, can be post-treated with solids, preferably bicarbonate and/or soda, particularly in amounts of 2 to 15 wt. %, based on the post-treated product. The post-treatment with the solids is also advantageously carried out in a spherolizer.

The fine particulate surfactant particles, particles and/or finished product also have the advantage that they are fast dissolving.

In a further embodiment of the invention, the inventive particles can be prepared, in particular, blended with additional ingredients of the detergent, care product and/or cleansing agents for manufacturing the finished product, wherein it is advantageous that ingredients can be added that are not amenable to spray-drying. It is generally known from the broad prior art which ingredients of detergents or cleansing agents are not amenable to spray-drying and which raw materials are usually added. Reference is made to the general literature for this. More exactly, only high temperature sensitive conventional ingredients of detergents or cleansing agents are listed, such as bleaching agents based on peroxidic compounds, bleach activators and/or bleach catalysts, enzymes from the class of proteases, lipases and amylases; or strains of bacteria or fungi, foam inhibitors in optionally granular and/or compounded form, perfumes, temperature sensitive colorants and the like, which are advantageously blended with the previously dried compositions and optionally post-treated products.

UV absorbers that become attached to the treated textiles and improve the light stability of the fibers and/or the light stability of the various ingredients of the formulation can also be subsequently added. UV-absorbers are understood to mean organic compounds (light-protective filters) that are able to absorb ultra violet radiation and emit the absorbed energy in the form of longer wavelength radiation, for example as heat. Compounds, which have these desired properties, are for example, the efficient radiationless deactivating compounds and derivatives of benzophenone having substituents in position(s) 2- and/or 4. Also suitable are substituted benzotriazoles, acrylates that are phenyl-substituted in position 3 (cinnamic acid derivatives), optionally with cyano groups in position 2, salicylates, organic Ni complexes, as well as natural substances such as umbelliferone and the endogenous urocanic acid. Biphenyl derivatives and principally stilbene derivatives have particular importance. They are commercially available as Tinosorb® FD or Tinosorb® FR from Ciba. As UV-B absorbers can be cited: 3-benzylidenecamphor or 3-benzylidenenorcamphor and their derivatives, for example 3-(4-methylbenzylidene) camphor, 4-aminobenzoic acid derivatives, preferably the 2-ethylhexyl ester of 4-(dimethylamino)benzoic acid, the 2-octyl ester of 4-(dimethylamino)benzoic acid and the amyl ester of 4-(dimethylamino)benzoic acid; esters of cinnamic acid, preferably 4-methoxycinnamic acid, 2-ethylhexyl ester, 4-methoxycinnamic acid, propyl ester, 4-methoxycinnamic acid, isoamyl ester, 2-cyano-3,3-phenylcinnamic acid, 2-ethylhexyl ester (Octocrylene); esters of salicylic acid, preferably salicylic acid, 2-ethylhexyl ester, salicylic acid, 4-isopropylbenzyl ester, salicylic acid, homomenthyl ester; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably 4-methoxybenzmalonic acid, di-2-ethylhexylester; triazine derivatives, such as, for example 2,4,6-trianilino-(p-carbo-2′-ethyl-1′-hexyloxy)-1,3,5-triazine and octyl triazone, or dioctyl butamidotriazone (Uvasorb® HEB); propane-1,3-dione, such as for example 1-(4-tert.butylphenyl)-3-(4′-methoxyphenyl)propane-1,3-dione; ketotricyclo(5.2.1.0)decane derivatives. Further suitable are 2-phenylbenzimidazole-5-sulfonic acid and its alkali-, alkaline earth-, ammonium-, alkylammonium-, alkanolammonium- and glucammonium salts; sulfonic acid derivatives of benzophenones, preferably 2-hydroxy-4-methoxybenzophenone-5-sulfonic acid and its salts; sulfonic acid derivatives of 3-benzylidenecamphor, such as for example 4-(2-oxo-3-bornylidenemethyl)benzene sulfonic acid and 2-methyl-5-(2-oxo-3-bornylidene) sulfonic acid and its salts.

Typical UV-A filters particularly include derivatives of benzoylmethane, such as, for example, 1-(4′-tert.-butylphenyl)-3-(4′-methoxyphenyl)propane-1,3-dione, 4-tert.-butyl-4′-methoxydibenzoylmethane (Parsol 1789), 1-phenyl-3-(4′-isopropylphenyl)-propane-1,3-dione as well as enamine compounds. Naturally, the UV-A and UV-B filters can also be added as mixtures. Beside the cited soluble materials, insoluble, light-protecting pigments, namely finely divided, preferably, nano metal oxides or salts can also be considered for this task. Exemplary suitable metal oxides are particularly zinc oxide and titanium oxide and also oxides of iron, zirconium, silicon, manganese, aluminum and cerium as well as their mixtures. Silicates (talc), barium sulfate or zinc stearate can be added as salts. The oxides and salts are already used in the form of pigments for skin care and skin protecting emulsions and decorative cosmetics. Here, the particles should have a mean diameter of less than 100 nm, preferably between 5 and 50 nm and especially between 15 and 30 nm. They can be spherical, however elliptical or other shaped particles can also be used. The pigments can also be surface treated, i.e. hydrophilized or hydrophobized. Typical examples are coated titanium dioxides, such as, for example Titandioxid T 805 (Degussa) or Eusolex® T2000 (Merck). Hydrophobic coating agents preferably include silicones and among them specifically trialkoxyoctylsilanes or Simethicones. Micronized zinc oxide is preferably used.

The UV absorbers are normally used in amounts of 0.01 wt. % to 5 wt. %, preferably from 0.03 wt. % to 1 wt. %.

However, other ingredients can be added to the inventive finished product and/or the inventive particles, for example “speckles” that differ in their color and/or shape from the appearance of the inventive particles. The speckles can have a similar to identical particle size distribution as the inventive particles as well as the same composition, but in a different color. Similarly, it is possible for the speckles to have the same composition as the inventive particles, are not colored, but have a different shape. Finally, it is preferred, however, that speckles which have the same composition as the inventive particles, differ from the latter in color and optionally also in their shape. In these cases the speckles merely contribute to make the appearance of the inventive particles and/or finished product more attractive—particularly for detergents, care products and/or cleansing agents.

In a further and absolutely preferred embodiment of the invention, however, the speckles comprise another chemical composition than do the inventive particles. Precisely here, due to another color and/or another shape, the consumer can be alerted to the fact that specific ingredients are comprised in the final product for specific purposes, for example bleaching or care aspects. These speckles may not only be spherical or rod-shaped; they can also have quite different shapes.

The added speckles or also other ingredients can, for example, be spray-dried, agglomerated, granulated, pelletized or extruded. As the inventive particles and/or the spray-dried products are advantageous in that they have an excellent rate of dissolution even in relatively cold water (30° C.), it is accordingly preferred to add to them additional kinds of ingredients and/or raw materials that likewise exhibit an excellent dissolution rate.

A further subject matter of the present invention relates to a method for the manufacture of the inventive particles.

In order to manufacture the inventive particles comprising fine particulate surfactant particles, the finely divided surfactant particles and at least one, preferably a plurality of detergent, care and/or cleansing active components, were shaped into particles, wherein the particles comprise the finely divided surfactant particles partially as discrete surfactant particles.

The fine particulate surfactant particles can be manufactured preferably by spray-drying and/or fluidized bed processes.

In order to manufacture the inventive particles, a powder comprising at least one detergent-, care- and/or cleansing active component is preferably used, for example a tower powder such as a spray product or spray-dried product, wherein the powder is mixed with the fine particulate surfactant particles so as to produce the inventive particles.

In the context of the present invention, a spray product is also understood to mean a direct spray-dried product that is the spray-dried product without any further after treatment. Especially in regard to the fineness of the obtained powder, i.e., the finely divided surfactant particles, reference is made to the fact that the powder can exhibit to a relatively high degree a uniform particle distribution without the need for further conventional post-treatments known from the prior art, such as comminution and/or sieving out larger constituents or sieving off dust. In industrial production, these types of steps always lead to a complication of the process mostly involving a loss in product yield and thereby a cost increase for the finished product.

In the context of this invention, the powder used for manufacturing the particles can, however, also comprise or consist of spray-dried products that are subsequently post-treated or mixtures of the direct spray-dried product and post-treated spray-dried product.

Consequently, it is particularly preferred if the inventive particles are produced essentially from fine particulate surfactant particles and a mixture of compounds, preferably in the form of a spray-dried product, comprising at least one detergent-, care-, and/or cleansing active component. For example, the spray-dried product and the fine particulate surfactant particles can be agglomerated with the help of water in a cascade mixer to yield a uniform, fine, very free-flowing, inventive particle-granule.

The inventive particles can be at least partially still post-treated. The post-treatment can involve any post-treatment known from the prior art, in so far that the particles do not lose their inventive properties. Possible post-treatments and usable components are described in detail in the description of the present invention and to avoid any repetition, are referenced here.

The fine particulate surfactant particles can be granulated or agglomerated in a mixer together with a powder comprising at least one detergent-, care- and/or cleansing active component to the inventive particles. Water may be added for the granulation. Optionally, the inventive particles have to be dried to remove excess water.

The inventive finished product is obtained by adding usual colorants, perfumes, detergent-, care- and/or cleansing active components to the inventive particles. The inventive finished product can especially comprise the inventive particles, exclusively or also essentially, i.e. >50 wt. %, based on the finished product.

According to a further embodiment of the finished product, it can also, however, comprise fine particulate surfactant particles as such in combination with inventive particles, or fine particulate surfactant particles as such in combination with inventive particles and an addition of usual colorants, perfumes, detergent-, care- and/or cleansing active components.

The inventive particles can be manufactured, for example, by agglomerating the fine particulate surfactant particles together with the mixture of compounds with the help of water in a cascade mixer, wherein the inventive particles comprise the fine particulate surfactant particles as discrete surfactant particles.

The mixture of compounds preferably comprises a non-ionic surfactant and at least one salt selected from the group comprising carbonate salts, such as sodium carbonate, sodium hydrogen carbonate and/or sulfate salts such as sodium sulfate.

However, the mixture of compounds can also hold at least one component selected from the group comprising anionic surfactants, cationic surfactants, amphoteric surfactants, non-ionic surfactants, builders, bleaching-agents, bleach activators, bleach stabilizers, bleach catalysts, enzymes, polymers, co-builders, alkalising agents, acidifiers, anti-redeposition agents, silver protection agents, colorants, optical brighteners, UV-protection agents, softeners, inorganic salts, organic salts and/or rinse aids.

To manufacture the inventive particles, the fine particulate surfactant and the mixture of compounds can be mixed in a mixer, preferably plow share mixers, a continuous granulation unit with 2 wt. % water, based on the total weight of the fine particulate surfactant and the mixture of compounds. The residence time in the mixer can be up to 300 seconds, preferably 20 seconds to 60 seconds, a residence time in the range of 30 seconds to 40 seconds being preferred and 35 seconds being most preferred. It is advantageous if the mixer is run with choppers. The mixture can be subsequently granulated in a vertical mixer with 2 wt. % water, based on the total weight of the fine particulate surfactant and mixture of compounds, wherein the knife is preferably adjusted to 3°. The residence time is preferably 1 second for distributing the water (granulation water). The mixture is then dried. The resulting inventive particles have a high bulk density and a simultaneously high free flowability.

The measuring methods are given below.

Principle of the Fines Content Determination.

Samples of 50 g were tested by depositing each sample on a vibrating conveyor, the frequency of the vibration conveyor being 50 Hz and the opening gap adjusted such that the sample runs through the vibrating conveyor in 1 minute; the sample falls through the hopper and the filling tube into the cylinder and is collected in the container, during which time the dust is collected outside this container on the base plate. Any sample residues remaining in the hopper were transferred through the filling tube into the cylinder by careful tapping on the hopper. After a displacement period of 2 minutes, the dust that had settled on the brightly polished base plate was transferred with a spatula into a weighing dish and weighed out.

The apparatus for measuring the fines content was designed in such a way that samples could be allowed to fall through a vibrating conveyor and hopper into a closed cylinder through a filling tube, the fall height, measured from the filling tube outlet opening to the upper external base plate, being 50 cm. While the coarse fraction of the sample was collected in a 10 cm high and 18 cm diameter collection vessel that was located vertically and centrally on the base of the cylinder under the hopper, the fines—dust—were distributed over the whole of the base plate of the cylinder. After the fines had been allowed to settle in the cylinder, the fines were gathered together on the base plate of the cylinder with a spatula, collected in a container and weighed.

Equipment.

A conventional laboratory vibrating conveyor was used, manufactured by AEG, type DR 50 220 V, 50 Hz, 0.15 A.

The hopper, made of iron sheet with a wall thickness of 2 mm, had an upper diameter of 15 cm and an outlet diameter of 1.8 mm. The length of the hopper tube was 8 cm.

The brass filling tube had a wall thickness of 1 mm, a length of 30 cm and a diameter of 2.5 cm. The immersion depth of the tube into the external cylinder was 20 cm. The immersion depth of the tube was held constant by means of a 15 cm diameter, 1 mm thick brass disk that was soldered to the outer wall of the filling tube.

The cylinder was 70 cm high with a diameter of 40 cm, closed at the top and open underneath. The base plate of the cylinder was provided with a centrally located, ca. 3 cm diameter circular opening to receive the hopper outlet tube. The lower edge of the cylinder was flanged towards the exterior and soldered so as to eliminate the sharp edge. The cylinder was made of galvanized steel plate with a wall thickness of 1 mm.

The container was 10 cm high and 18 cm in diameter. The container was open at the top and closed at the bottom. The lower edge of the container was flanged towards the exterior and soldered so as to eliminate the sharp edge. The container was made of galvanized steel plate with a wall thickness of 1 mm.

The base plate was made of 1 mm thick, polished aluminum, was round in shape with a diameter of 48 cm.

The spatula was made of iron plate with a thickness of 2 mm and had a working surface width of 11 cm.

The analytical balance was accurate to 0.01 g.

A conventional laboratory weighing dish was used for the weight determination of the fines (dust) fraction.

The fines content was expressed in % based on the weights of each sample.

Clumping test.

In the clumping test, 15 ml of the test sample were transferred into a hollow cylinder with an internal diameter of 25 mm and pressed for 30 minutes using a ram that was loaded with an additional 500 g. The compacted cylindrical sample was carefully pushed out and then, in a vertical position, loaded under defined conditions until break. The required load in grams is a measure of the clumping tendency.

The clump test value is given in g.

Dissolution Behavior.

The dissolution behavior was determined as follows. Each of the samples under test was stirred in a glass beaker in 200 ml tap water (15° d), held at 30° C. and 10° C. respectively, with the help of a motorized stirrer equipped with 4 impellers bent downwards at an angle of 300 and stirred at a constant number of revolutions of 700 rpm. The distance of the impellers from the bottom of the container was 2.5 cm. The sample (1 g) was carefully poured in, avoiding any clumping in the formed stirring cones. After 90 seconds, the solution was poured through a 7 cm diameter tared sieve whose mesh size was 0.1 mm and sucked off by means of a suction flask. Any substance residues remaining in the glass beaker were transferred onto the sieve using the least possible amount of injected water. After drying for a period of 24 hours in air, the sieve was reweighed.

The residue formation as well as the dissolved sample fraction at 30° C. and 10° C. are expressed in %.

Sedimentation Test.

The samples under test (10 g) were added in small portions to 90 ml of tap water (16° dH) in a beaker under vigorous stirring. Stirring was continued at room temperature for 15 minutes. The solution was then poured into a measuring cylinder and allowed to stand. The measuring cylinder was covered with a film for the duration of the holding time. After 20 hours, the ratio of the sediment volume Vs to the total volume V was determined.

Equipment.

Beaker.

250 ml, diameter 70 mm

Stirrer.

Three bladed propeller stirrer, diameter 50 mm, rotational speed 700-1,000 min⁻¹ Measuring cylinder.

100 ml measuring cylinder specified by DIN

The sedimentation test values are expressed in ml.

Flow Test.

The flow time of 1,000 ml of each sample from a normalized hopper was measured and compared with the flow time of standardized test sand. The flow time of the dry test sand from the flow apparatus was set to 100%. The flow times of the particles out of the flow apparatus were calculated as the ratio and expressed as % flow time compared with the test sand.

Properties of the Test Sand:

| | |
|---|---|
| Bulk density | 1,460 g/l |
| Particle size distribution: | >1.6 mm = 0.2% |
| | 0.8 mm and ≦1.6 mm = 11.6% |
| | 0.4 mm and ≦0.8 mm = 56.2% |
| | 0.2 mm and ≦0.4 mm = 26.6% |
| | >0.1 mm and ≦0.2 mm = 4.8% |
| | <0.1 mm = 0.6% |

The particle size distribution of the test sand is weighed together from fractionated building sand and is based on an average distribution of a washing powder.

Prior to calibrating the flow hopper by sample separation, the test sand is separated into a volume of 1,000 ml from a larger holding tank.

Equipment.

Bulk density apparatus with 1,000 ml beaker

Flow test apparatus (consisting of a flow test hopper and support)

Stopwatch

Powder hopper (for filling the apparatus)

2 liter plastic container (to receive the discharged sample materials)

Experimental

Calibration of the Flow Test Apparatus.

The discharge time of the test sand is determined for the flow test apparatus by measuring the discharge time of 1,000 ml test sand five times. The average discharge time is set as 100%. Care should be taken to ensure that the discharge time of the test sand is 50 seconds. Otherwise, the discharge orifice of the hopper must be corrected.

Sample Measurement.

A 1,000 ml sample is transferred into the flow test apparatus. For an easier filling of the flow hopper, the apparatus is filled with the sample with the help of a large powder hopper. When the vertically standing flow test apparatus is filled from above with the sample, the bottom discharge orifice of the flow test apparatus hopper has to be closed (with a finger). After opening the discharge orifice of the flow test apparatus hopper, the time in seconds for the sample to completely run out of the flow test hopper is measured with a stopwatch.

The discharge time for 1,000 ml of each sample is measured five times and the average calculated.

The discharge time for the test sand in seconds is multiplied by 100 and divided by the discharge time of the sample in seconds and gives the flow test result in %.

### EXAMPLES

Fine Particulate Surfactant Particles (FS).

| | FS 1 | | FS 2 | | FS 3 | |
|---|---|---|---|---|---|---|
| Particle diameter D₅₀ | 0.15 | mm | 0.2 | mm | 0.25 | mm |
| Fines content | 0.05% | | 0.02% | | 0.01% | |
| Composition: | | | | | | |
| Na-alkylbenzene sulfonates | 10 | wt. % | — | | — | |
| C₁₁-C₁₃ | | | | | | |
| Na-dodecylbenzene sulfonate | — | | 15 | wt. % | — | |
| Na-dodecylbenzene sulfonate | — | | — | | 25 | wt. % |
| Fatty acid C₁₆-C₁₈ | 3 | wt. % | 2 | wt. % | 1 | wt. % |
| Sodium carbonate | 20 | wt. % | 15 | wt. % | 10 | wt. % |
| Silicate | 10 | wt. % | 9 | wt. % | 8 | wt. % |
| Sodium sulfate | 43 | wt. % | 42 | wt. % | 41 | wt. % |

Rest ad 100 wt. % sodium sulfate and water 4 wt. %-8 wt. %.

Compound Mixture (CM).

| Composition: | CM 1 | CM 2 | CM 3 |
|---|---|---|---|
| C₁₁-C₁₅ Fatty alcohol ethoxylate*¹ | 10 wt. % | — | — |
| C₁₂-C₁₈ Fatty alcohol ethoxylate*² | — | 15 wt. % | — |
| C₁₂-C₁₈ Fatty alcohol ethoxylate*² | — | — | 25 wt. % |
| Sodium carbonate | 20 wt. % | 15 wt. % | 10 wt. % |
| Sodium hydrogen carbonate | 5 wt. % | 5 wt. % | 5 wt. % |

Rest ad 100 wt. % sodium sulfate and water ≦1 wt. %.
*¹C₁₂-C₁₄ Fatty alcohol ethoxylate with an EO degree of 3 (Dehydol LS 3 ®)
*²C₁₂-C₁₈ Fatty alcohol ethoxylate with an EO degree of 7 (Dehydol LT 7 ®)

Composition of the Particles.

To manufacture inventive particles, each one of the above-mentioned example compositions for fine particulate particles FS 1 to FS 3 can be mixed with each one of the compound mixtures CM 1 to CM 3 in the amounts given below and with the addition of the given quantities of water.

| Composition: | Example 1 | Example 2 | Example 3 |
|---|---|---|---|
| Fine particulate surfactant particles | 55 wt. % | 65 wt. % | 70 wt. % |
| Compound mixture | 40 wt. % | 33 wt. % | 27 wt. % |
| Water | 5 wt. % | 2 wt. % | 3 wt. % |

Composition of the Finished Product.

For an inventive finished product, any of the particles obtained by combining the fine particulate particles FS 1 to FS 3 with each one of the compound mixtures CM 1 to CM 3 in the weight ratios of examples 1 to 3 can be further mixed with the detergent components given below to afford the finished products FP 1 to FP 3.

| | FP 1 | | FP 2 | | FP 3 | |
|---|---|---|---|---|---|---|
| Composition: | | | | | | |
| Particles | | | | | | |
| Particles | 73 | wt. % | 70 | wt. % | 80 | wt. % |
| Added detergent components | | | | | | |
| Bleaching agent | 16 | wt. % | 18 | wt. % | 10 | wt. % |
| Tetraacetyl ethylene diamide (TAED) | 5 | wt. % | 5 | wt. % | 5 | wt. % |
| Foam inhibitor | 1 | wt. % | 1 | wt. % | 1 | wt. % |
| Enzymes | 1 | wt. % | 1 | wt. % | 1 | wt. % |
| Perfumes | <1 | wt. % | <1 | wt. % | <1 | wt. % |

Rest ad 100 wt. % water

1. Particles that comprise a mixture of compounds and fine particulate surfactant particles, at least partially as discrete surfactant particles, which comprise
a particle diameter of d₅₀ of 0.05 mm to 0.6 mm;
a fines content of ≧0% to 0.1%;
at least 1 wt. % to 30 wt. % surfactant; and
at least 10 wt. % to 40 wt. % sodium carbonate;
wherein the indicated weight percentages are based on the total weight of the fine particulate surfactant particles.

2. The particles according to claim 1, wherein the particles have a fines content of ≧0% to ≦0.2%.

3. The particles according to claim 1, wherein the particles comprise a mixture of compounds and fine particulate surfactant particles as primary and/or secondary surfactant particles.

4. The particles according to claim 1, wherein the particles have a particle diameter d₅₀ of 0.1 mm to 1.5 mm.

5. The particles according to claim 1, wherein the particles have a bulk density of at least 400 g/l.

6. The particles according to claim 1, wherein the particles have a free flowability of at least 80%.

7. The particles according to claim 1, wherein the particles exhibit a dissolution time of a maximum of 90 seconds at a water temperature of 10° C.

8. The particles according to claim 1, wherein 1 g of particles have a residue limit in tap water with 15° d and held at 10° C. of ≧1% to ≦5%.

9. The particles according to claim 1, wherein at least ≧96 wt. % of 1 g of particles dissolve in 200 ml of tap water with a water hardness of 15° d and held at 10° C. within a dissolution time of ≦90 seconds and dissolve in 200 ml of tap water with a water hardness of 15° d and held at 30° C. within a dissolution time of ≦90 seconds.

10. The particles according to claim 1, wherein a residue of ≧0 wt. % to ≦4 wt. % forms from 1 g of particles in 200 ml of tap water with a water hardness of 15° d and held at 10° C. within a dissolution time of 90 seconds, and forms from 1 g of particles in 200 ml of tap water with a water hardness of 15° d and held at 30° C. within a dissolution time of 90 seconds.

11. The particles according to claim 1, wherein in the clumping test, the particles have values of >0 g to ≦1 g.

12. The particles according to claim 1, wherein in the sedimentation test the particles have values of ≧0 ml to ≦2 ml.

13. The particles according to claim 1, wherein
≧0 to 5 wt. % of the particles have a particle diameter of <0.1 mm,
1 to 10 wt. % of the particles have a particle diameter of <0.2 mm to 0.1 mm,
50 to 70 wt. % of the particles have a particle diameter of <0.4 mm to 0.2 mm,
20 to 45 wt. % of the particles have a particle diameter of <0.8 mm to 0.4 mm, and
≧0 to 5 wt. % of the particles have a particle diameter of <1.6 to 0.8 mm,
based on the total weight of the particles, wherein each weight range is chosen such that together they total a maximum of 100 wt. %

14. The particles according to claim 1, wherein
≧to 2 wt. % of the particles have a particle diameter of <0.1 mm,
1 to 8 wt. % of the particles have a particle diameter of <0.2 mm to 0.1 mm,
55 to 65 wt. % of the particles have a particle diameter of >0.4 mm to 0.2 mm,
25 to 40 wt. % of the particles have a particle diameter of >0.8 mm to 0.4 mm, and
≧0 to 4 wt. % of the particles have a particle diameter of <1.6 to 0.8 mm,
based on the total weight of the particles, wherein each weight range is chosen such that together they total a maximum of 100 wt. %.

15. The particles according to claim 1, wherein
≧0 to 1 wt. % of the particles have a particle diameter of >0.1 mm,
1 to 3 wt. % of the particles have a particle diameter of <0.2 mm to 0.1 mm,
60 to 65 wt. % of the particles have a particle diameter of >0.4 mm to 0.2 mm,
30 to 38 wt. % of the particles have a particle diameter of >0.8 mm to 0.4 mm, and
≧0 to 2 wt. % of the particles have a particle diameter of <1.6 to 0.8 mm,
based on the total weight of the particles, wherein each weight range is chosen such that together they total a maximum of 100 wt. %.

16. The particles according to claim 1, wherein the proportion by weight of the fine particulate surfactant particles, based on the total weight of the particles having fine particulate surfactant particles, make up at least 10 wt. % to a maximum of 90 wt. %.

17. The particles according to claim 1, wherein the particles hold, in addition to the fine particulate surfactant particles, at least one of detergent-, care- and active cleansing substances, anionic surfactants, cationic surfactants, amphoteric surfactants, non-ionic surfactants, builders, bleaching-agents, bleach activators, bleach stabilizers, bleach catalysts, enzymes, polymers, co-builders, alkalizing agents, acidifiers, anti-redeposition agents, silver protection agents, colorants, optical brighteners, UV-protection agents, softeners, perfumes, foam inhibitors and rinse aids.

18. The particles according to claim 1, wherein the particles are post-treated with at least one component, wherein the quantity of the at least one component amounts to up to 15 wt. % based on the total weight of the post-treated particles.

19. The particle according to claim 1, wherein the mixture of compounds preferably comprises a non-ionic surfactant and at least one salt selected from the group consisting of carbonate salts, sodium carbonate, sodium hydrogen carbonate, sulfate salts and sodium sulfate.

20. The particles according to claim 1, wherein the mixture of compounds comprises at least one of anionic surfactants, cationic surfactants, amphoteric surfactants, non-ionic surfactants, builders, bleaching-agents, bleach activators, bleach stabilizers, bleach catalysts, enzymes, polymers, co-builders, alkalizing agents, acidifiers, anti-redeposition agents, silver protection agents, colorants, optical brighteners, UV protection agents, softeners, inorganic salts, organic salts and rinse aids.

21. The particles according to claim 1, wherein the particles comprise the mixture of compounds and the fine particulate surfactant particles in proportions by weight of 1:10 to 10:1.

22. A product comprising 5% to 100% of particles comprising a mixture of compounds and fine particulate surfactant particles, based on the total weight of the finished product, wherein each weight range is chosen in such a way that all together they amount to a maximum of 100 wt. %, wherein the fine particulate surfactant particles are present, at least partially, as discrete surfactant particles, and comprise
a particle diameter d₅₀ of 0.05 mm to 0.6 mm;
a fines content of ≧0% to 0.1%;
at least 1 wt. % to 30 wt. % surfactant; and
at least 10 wt. % to 40 wt. % sodium carbonate;
wherein the indicated weight percentages are based on the total weight of the fine particulate surfactant particles.

23. The product according to claim 22, further comprising at least one component selected from the group consisting of detergent-, care-, and active cleansing substances, anionic surfactants, cationic surfactants, amphoteric surfactants, non-ionic surfactants, builders, bleaching-agents, bleach activators, bleach stabilizers, bleach catalysts, enzymes, polymers, co-builders, alkalizing agents, acidifiers, anti-redeposition agents, silver protection agents, colorants, optical brighteners, UV-protection agents, softeners, perfumes, foam inhibitors and rinse aids.

24. A process for the manufacture of particles, which comprises the step of mixing compounds and fine particulate surfactant particles, at least partially as discrete surfactant particles, which comprise
a particle diameter of d₅₀ of 0.05 mm to 0.6 mm;
a fines content of ≧0% to 0.1%;
at least 1 wt. % to 30 wt. % surfactant; and
at least 10 wt. % to 40 wt. % sodium carbonate;
wherein the indicated weight percentages are based on the total weight of the fine particulate surfactant particles, said process also comprising the further steps of
manufacturing the finely divided surfactant particles and
forming particles comprising finely divided surfactant particles and at least one detergent-, care- or active cleansing component,
wherein the particles comprise the finely divided surfactant particles at least partially as discrete surfactant particles.

25. The process for manufacturing particles comprising a mixture of compounds and discrete fine particulate surfactant particles according to the process of claim 24, wherein the particles are produced essentially from finely divided surfactant particles and a mixture of compounds comprising at least one detergent-, care-, or active cleansing component.
